(19) United States
(12) Patent Application Publication
(10) Pub. No.: US 2008/0222279 A1
(43) Pub. Date: Sep. 11, 2008

(54) System for creating collective intelligence through multi-linear discussion over an electronic network

(76) Inventors: Lucas Cioffi, Killeen, TX (US); Fernando Zapata, Austin, TX (US)

Correspondence Address: ANDREW G. DINOVO;DiNOVO PRICE ELLWANGER & HARDY LLP, 7000 N. MOPAC EXPRESSWAY, SUITE 350, AUSTIN, TX, 78731, US

(21) Appl. No.: 11/716,321

(22) Filed: Mar. 9, 2007

(51) Int. Cl. G06F 15/173

(52) U.S. Cl. 709/223

(57) ABSTRACT

A system that assembles diverse individual thoughts into collective intelligence, making possible a structured conversation by a networked community. Participants contribute ideas to a robust conversational framework in modular form. This framework ensures that the conversation remains structured and continues on track. Each idea module competes with its peers through an interactive rating process controlled by the community. The resulting conversation represents collective intelligence arranged into at least two opposing viewpoints. The invention then enables these discussions to translate into real-world action by empowering the community with collaborative tools.

### FIELD OF THE INVENTION

The present invention relates generally to the field of communications over an electronic network, and more specifically to electronically mediated communication and collective intelligence, including methods for organizing disparate and conflicting information into knowledge.

### BACKGROUND OF THE INVENTION

Methods for aggregating diverse and of times conflicting opinions are central to the efficient functioning of human organizations. In the communication age, widespread and far-reaching electronic networks have created immense potential for collaboration across space and time. The World Wide Web is presently the network at the center of many such opportunities for collaboration.

Message boards, chat rooms, discussion forums, wikis and blogs are some of the most common methods of collaboration on the Web. Although they have many distinct advantages, each is presently more conducive to wayward threads of thought than to simultaneous conversations organized in parallel.

More and more, members of networked communities commonly post comments on the content they encounter. Comments may be rated by the members themselves and then filtered so that only the best comments are displayed. Alternatively, comments may be filtered chronologically so that only the most recent comments are displayed.

The most significant disadvantage of this framework for networked conversation is that it does not perform well as the scale increases; discussions become significantly harder to follow as the audience grows in size. This lack of scalability is critical, because large groups are not able to harness the full potential of their greatest asset: the collective knowledge of their individual members. A more rigorous conversational infrastructure is thus needed to manage large-scale, networked conversations.

Embodiments of the present invention provide at least three advantages over the current technologies: scalability, situational awareness, and ease of use.

Embodiments of the framework provide the ability to handle networked conversations that are several orders of magnitude larger than those that exist today. Whereas larger groups make linear forum discussions unmanageable, our multi-linear framework allows trains of thought to diverge while still holding the overall conversation together. Our software capitalizes on the wisdom of crowds; redundant modular points compete against each other so that only the strongest survive. The larger the conversation, the more competition, and therefore the stronger the best points are likely to be.

The system may also provide enhanced situational awareness to its users. The system can replace the typical confusion generated by linear discussion forums with a robust framework and graphical user interface. This framework can be represented with an interactive conversation map that provides a bird's-eye view of the discussion. Using the map, community members may explore trains of thought and, upon reaching a dead end, may quickly navigate back to their previous location. This capability empowers individual community members to customize their search; they may choose to explore points in the exact order that seems most logical to them, creating a much more enjoyable experience.

Moreover, the proposed system enjoys ease of use. Existing advanced forum software may be fine for the computer-savvy to use, but is often too intimidating for novices. The present invention allows opening debates up to as wide an audience as possible. In order to do so, new corners must be able to contribute quickly and easily. For example, a preferred embodiment of the invention uses a color-coded graphical user interface which is intended to be intuitive even to those that are not experienced with online debate.

Further objects and advantages of our invention will become apparent from a consideration of the drawings and ensuing description.

### SUMMARY OF THE INVENTION

This invention combines the strengths of real-world debate with the power of electronically mediated communication. It essentially allows everyone to shout at once yet is able to manage the chaos; members of a networked community compress points into concise modules and then place them within a robust conversational framework. The community members then rate the modules in order to weed out the weaker points and advance the stronger. The result is a system that assembles collective intelligence from individual contributions.

### BRIEF DESCRIPTION OF THE DRAWINGS

The foregoing and other advantages of the invention will become apparent upon reading the following detailed description and upon reference to the drawings, wherein:

FIG. 1 illustrates the response phase of a debate in accordance with the present invention;

FIG. 2 illustrates the rating phase of a debate in accordance with the present invention.

FIG. 3 is a graphical representation of a storage system in accordance with the present invention.

FIGS. 4-10 are flowcharts illustrating steps for various components of the process described herein.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

### Static Structure

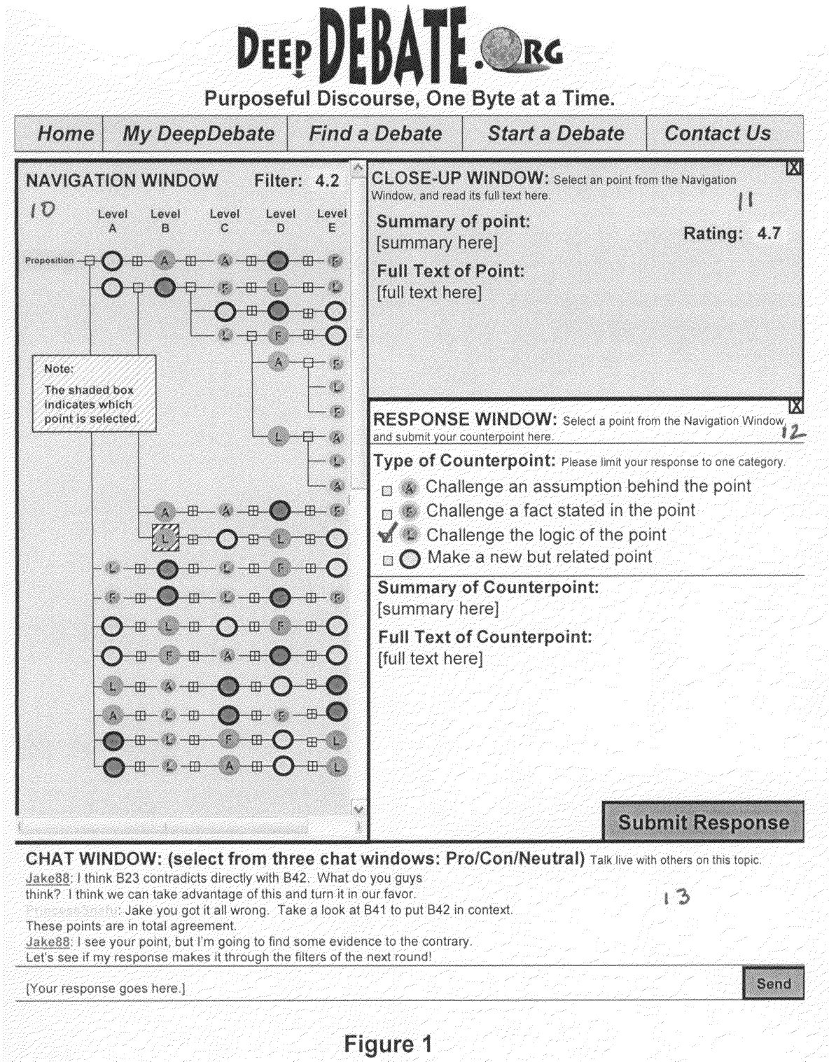

FIG. 1 shows a layout of an example debate in accordance with the invention. Several windows are visible: the Navigation Window 10, Close-up Window 11, Response Window 12, and Chat Window 13.

The Navigation Window 10 is the bird's-eye view of the debate. It contains a unique tree structure that is the underlying framework of the debate. Each node on the tree represents a point or counterpoint module. Green points support the resolution; red points are against the resolution. The letter “A” with a line through it means that counterpoint is offered as a challenge to the assumptions in point module attached to the left. The letter “F” likewise indicates a challenge to facts, the letter “L” indicates a challenge to logic, and the absence of a letter indicates a new, related point.

Within the Navigation Window 10, a member may move left, right, up, and down through the debate using the scroll bars on the right side and bottom. A member may respectively expand or contract branches on the tree by left-clicking the plus or minus sign to the right of a module icon. The leftmost green and red nodes are placeholders for creating new top-level points supporting or opposing the plan or proposition.

The Close-Up Window 11 provides an area to view the summary, rating, full text, and other data about a point or counterpoint. The Close-Up Window may be subdivided into two halves so that when a user selects a module to be displayed in one half of the window, the argument to which it is a direct response can be automatically displayed in the other half.

The Response Window 12 provides the means for a member to comment on an argument module or to categorize and propose a new counterpoint module. The Response Window may contain functionalities such as hyperlinking, uploading images and videos, and quoting the opposing argument to enable the user to better make his or her point.

The Chat Window 13 provides a mechanism for the community to communicate using text-enabled chat, voice-enabled chat, and/or video-enabled chat.

### Operation

The present form of the invention has several characteristics which are central to its operation and many which add value in non-essential ways. The main characteristics deal primarily with the methods of submitting and rating argument modules.

Main Characteristics

The debate may be broken down into two alternating phases: the Response Phase and the Rating Phase. A debate begins with the Response Phase to the proposition or plan of action. On screen the Navigation, Close-Up, and Response Windows are visible.

The Navigation Window 10 provides a bird's-eye view of the debate and is most useful as a graphical representation of the debate's underlying structure. Each argument in the debate appears in the Navigation Window in the form of a green or red circle. Green circles represent actions in support of the plan of action or proposition; red circles represent actions opposing the plan of action or proposition. Letters within these circles further categorize arguments; an “A” indicates a challenge to an implicit or explicit assumption; an “F” indicates a challenge to a proposed fact; an “L” indicates a challenge to the proposed logic; the lack of a letter indicates a new, related point.

In the Navigation Window 10, two treelike structures connect argument modules to one another. There are two “trunks” to these tree structures to which all other arguments link. The green trunk is for the initial set of arguments in support of the plan and the red trunk is for the initial set of arguments opposing the plan. These initial argument modules link to the trunks through collapsible and expandable branches. Branches indicate the direction of the debate which progresses from left to right. A plus sign to the right of a node in the tree indicates that there are several hidden branches that a user can view by expanding. A minus sign indicates that the user may collapse the displayed branches.

After the initial arguments, the nodes on a branch alternate between pro and con until the end of the debate. For example, an initial green (pro) argument may have several red (con) counterarguments, which in turn, all may have several green (pro) counterarguments. The user may prioritize the order in which the branches appear or filter out argument modules according to ratings, number of views, time of posting, or other data. All the top nodes on a branch from its origin at a trunk on the left to its termination at the right remain visible to provide a quick overview of the top arguments.

Members may move their mouse over an argument icon in the Navigation Window and the summary of the point will appear in a small popup window near the mouse. If the user selects the argument, the full text of the argument will appear in the Close-Up Window, along with the rating and other data associated with the argument. In the Close-Up Window, argument modules may contain videos, audio clips, hyperlinks, footnotes, or other means of conveying information.

Using the Response Window 12, users may submit counterpoints to the selected points. Users may label these counterpoints with one of the following tags 1) challenging an underlying assumption of the point 2) challenging a fact in the point 3) challenging the underlying logic of the point or 4) making a new, related counterpoint. These counterpoints can be regarded as modules, because many users may submit many counterpoints to the same point that will then compete among each other for the best positioning within the debate.

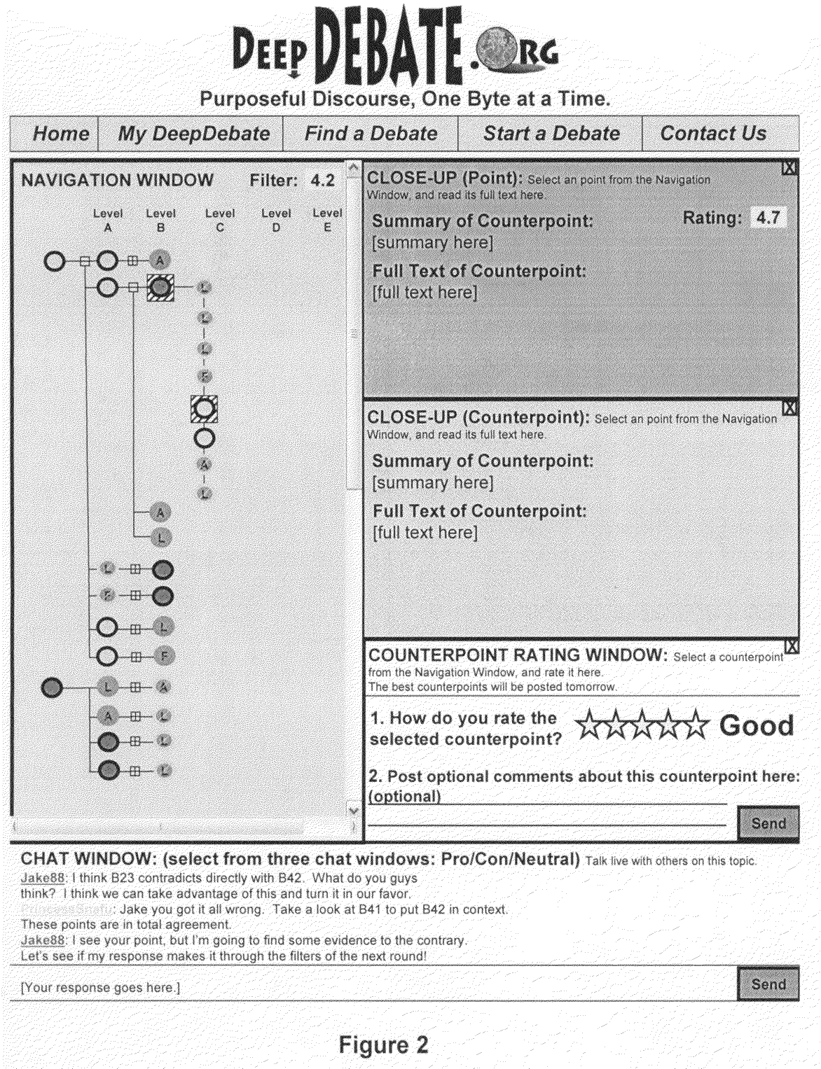

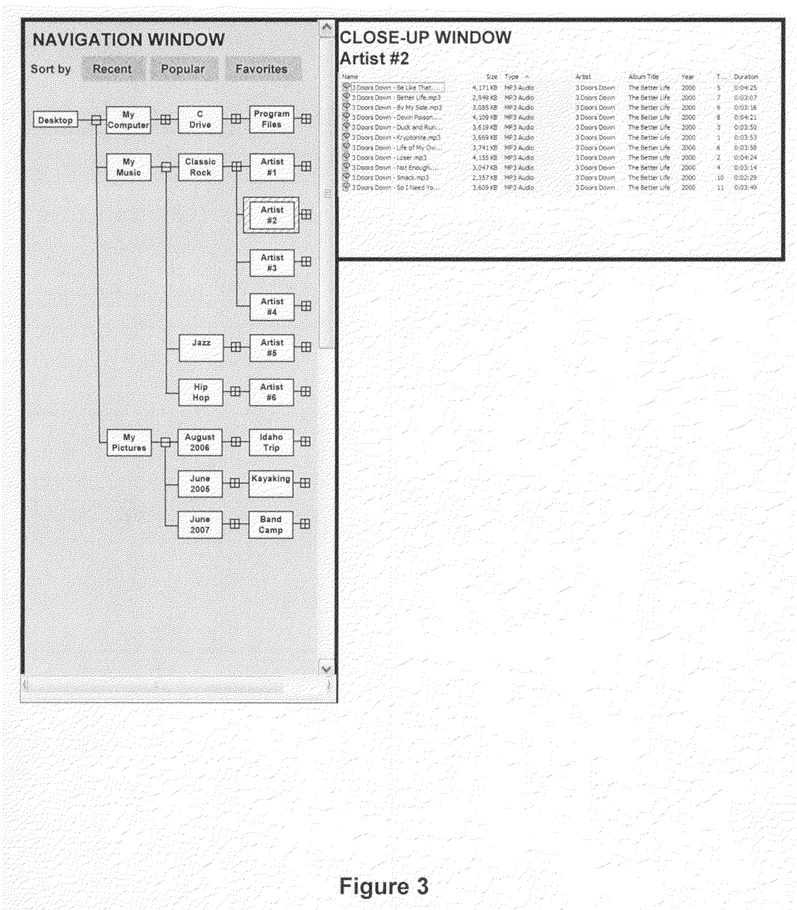

After a certain period of time, the Response Phase will close and the Rating Phase will begin. In this second phase, members of the community will evaluate point modules or counterpoint modules to select which ones will rise to the top of the debate and should have the most prominent positioning within the Navigation Window. Members will rate modules on a 1-5 scale, attach optional comments, and mark them as common ground if they are not points of contention. These actions occur in the Response Window 12 that can be seen in further detail in FIG. 2. Prior to the Rating Phase, none of the responses to be rated are visible. The advantage of a distinct Rating Phase is in preventing the earliest argument modules from accumulating votes merely because they were posted first.

During the Response Phase, the Close-Up Window 11 is split in halves, one half for a Point Close-Up Window and one half for a Counterpoint Close-Up Window. This gives the user the ability to simultaneously read both the point and one of its counterpoints in detail. Only the points proposed in the last Response Phase are available for rating in any given Rating Phase. When a user selects one of these points, several of its counterpoints become immediately visible within the tree structure. The system determines which points to display through a method that is based on random selection. Each time a user selects a point, a different sampling of random counterpoints is visible. Users are prevented from rating their own counterpoints.

Each time an argument module of a particular member is rated highly, the member gains “local clout” within that particular side of that debate. Local clout in turn adds weight to that member's ratings of the argument modules of others. At the conclusion of the Rating Phase, the system will calculate the weighted averages of each module, taking into account the local clout of each user. As the debate progresses, some members will gain more and more local clout, depending upon their contributions to the debate. In this manner the community rewards those that make meaningful contributions who, in turn, reinvest this local clout back into the debate. The result is an iterative channeling of power into the hands of those whose personal interests and actions are most in line with those of the community.

The debate alternates between these two phases until the conclusion of the debate. Those members of the community with local clout above a certain threshold are enabled to participate in a collaborative drafting of the conclusion. The conclusion consists of a collective opinion in support of the plan and a collective opinion against the plan. The best currently available technology for accomplishing this is wiki software. Conclusions can be used to form petitions, or even influence referenda or legislation.

There are several checks against abuse of the system. First, in order to have a significant impact on the ranking of arguments on a particular side of a debate, a member must have previously made worthwhile contributions to that specific side of the debate as determined by the community, thereby earning local clout. Second, in order to prevent destructive collaboration, the system presents argument modules during the Rating Phase anonymously and randomly. Third, as Wikipedia.Org has demonstrated, a sizeable and motivated community will minimize the influence of a minority of vandals.

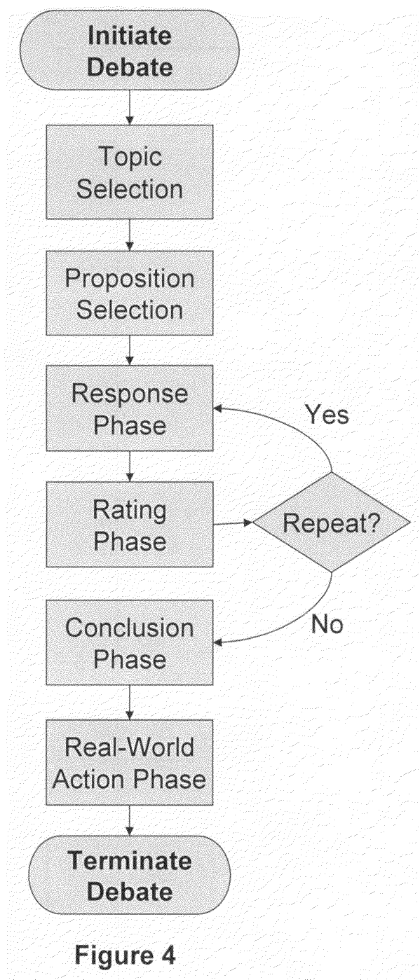

The flowchart shown in FIG. 4 provides an overview of the internal processes of the debate. The first process is Topic Selection in which the community decides the general subject matter of the debates that will follow. Next the community selects which specific propositions or plans of action will be up for debate. The debate opens with the Response Phase, in which the community may contribute arguments both for and against the proposition. At the conclusion of the first Response Phase, a separate Rating Phase begins. The debate then alternates between additional Response and Rating Phases in accordance with the parameters of the debate. After the final Rating Phase, the debate moves into the Conclusion Phase where participants contribute to collective summaries highlighting the main points of each side. After the Conclusion Phase each side has the opportunity to organize real-world action in support of their cause.

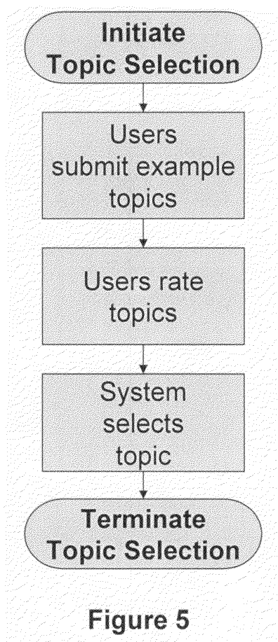

As shown in FIG. 5, the Topic Selection Phase allows members of the community to suggest which topics will be the focus of future debates. Each member is permitted to rate the topics submitted by other members. The system compiles these ratings and then selects the topic for the next set of debates. Each debate centers upon a different proposition or plan of action which falls under the general topic.

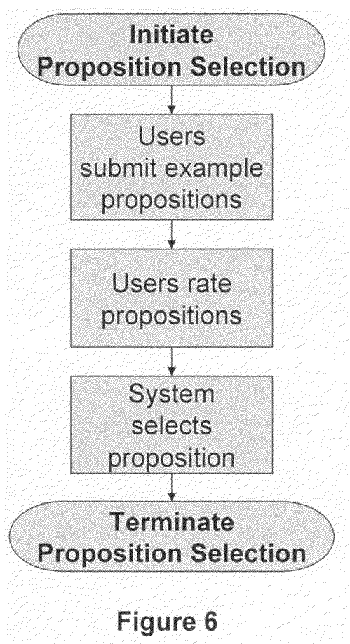

Referring now to FIG. 6, the Proposition Selection Phase allows members of the community to suggest which propositions or plans of action will be up for debate. Each member is permitted to submit several propositions with detailed plans of action that fall within the limits of the selected topic. The community then rates each plan of action to determine which ones will make the best debates. The system selects the top plans of action to become the centers of separate debates.

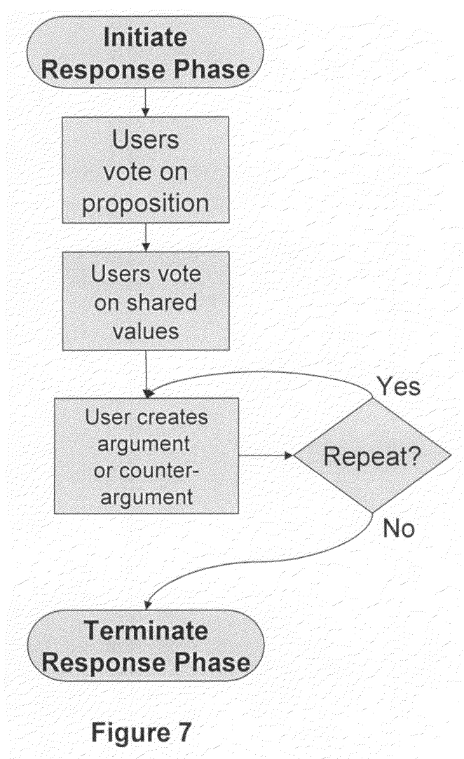

During the Response Phase illustrated in FIG. 7, members of the community have the opportunity to vote for, against, or remain neutral to the proposition. Members then have the chance to submit and vote on values that they may or may not share with the opposing side. Finally, members may submit multiple arguments for or against the proposition or may make specific counterarguments to the arguments of the opposing side. The submission of arguments and counterarguments is the most critical step in the debate.

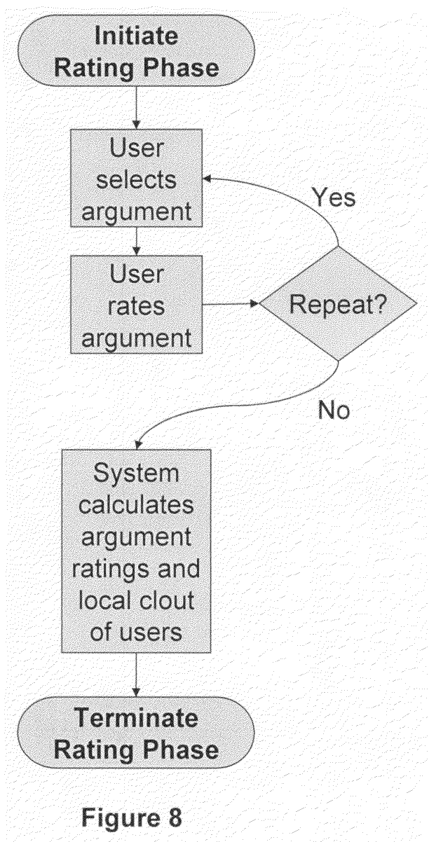

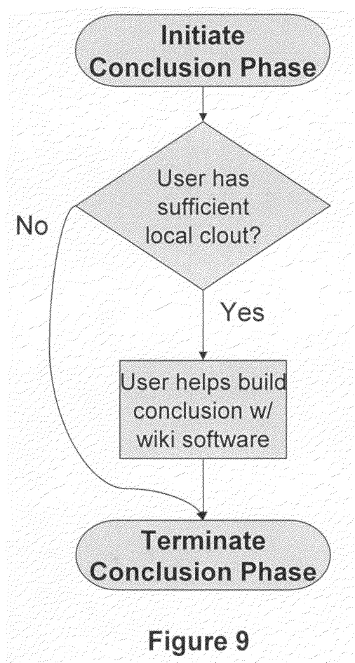

During the Response Phase (FIG. 8), community members may begin rating all arguments submitted during the last Response Phase. The system presents a random selection of responses to each community member. Authors of each argument remain anonymous until the completion of the Rating Phase. The system selects the best arguments based on the weighted average of the community's ratings and posts them to the debate. The weighted average is dependent upon each member's local clout and their rating of each argument. The system alternates between the Response Phase and the Rating Phase in accordance with the parameters of the debate. 100421 As shown in FIG. 9, after the final Rating Phase, the debate moves into the Conclusion Phase. Participants who have local clout above a certain threshold are permitted contribute to collective summaries highlighting the main points of each side. These members may highlight which arguments within the debate they found especially convincing. Each side refines its position using collaborative software such as wikis and chat.

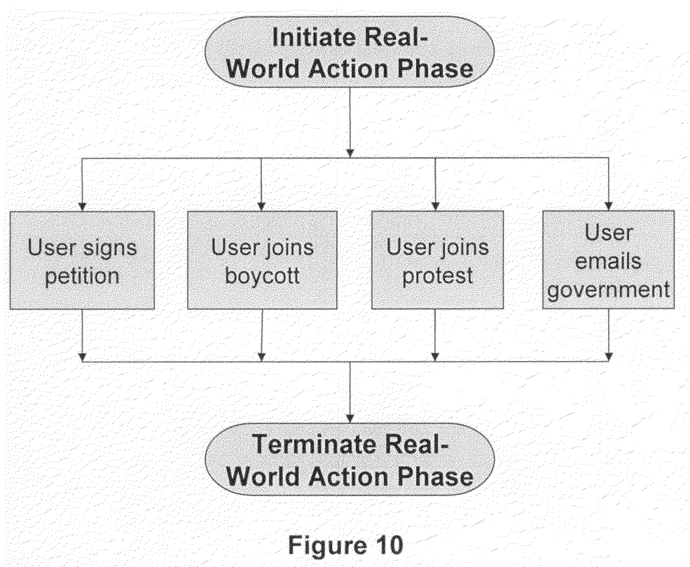

Referring to FIG. 10, upon conclusion of the debate, each side may organize to take real-world action in support of their cause. Using the social network within the system, members may collaborate for the purpose of signing petitions, organizing boycotts, forming protests, contacting their elected officials, or by taking other collective action.

Peripheral Characteristics

There are several other characteristics to the system which may be added in alternative embodiments. During the Preparation Phase, for example, members of the community will set the debate agenda several weeks prior to the debate. The community will submit topics for consideration and then vote on the best ones. An example topic could be “National health care reform”. Voting may or may not be weighted by the “global clout” of each member. Global clout will be described in detail below.

In the two weeks prior to the start of a debate, members of the community may submit detailed plans of action to be evaluated by the community. The best five or so plans will each become the center of their own separate debate within the overall topic area. Plans of action may be submitted in paragraph form or broken down into small components so that they are conducive to structured debate.

The community may also create a collective pool of values that members will individually prioritize when they vote on the proposition. This may indicate that members with opposing viewpoints actually agree on values (or ends) but disagree on the means to achieve them. The community may also build a library of hyperlinked resources that will be useful in the upcoming debate.

The system may allow users to display data within the system in the form of charts or maps. For example a user may want to compare the percentage of New Yorkers who voted for a particular immigration reform to the percentage of Californians who did the same. A different user may want to filter out all American IP addresses from a debate about the American image abroad.

Technologies such as voice chat, text chat, wikis, and other collaborative tools may prove useful. Groups forming on different sides of an issue may need to organize before, during, and after a debate. Access to such tools could be public or restricted by invitation, local clout, or other means.

Profile pages of individuals and groups will aid in the networking potential of the system. A profile page may contain any combination of the following items: an avatar, photos, videos, audio content, demographic data, a platform linked to debates, a means for graphically comparing that platform to the platforms of other members, a public comment section, a means for sending and receiving private messages, a method for determining whether the individual/group is currently online, links to external sites, a list of that member's contributions to the system and which ones are currently open to debate, data about that member's contributions, favorite debates, debates on a watch list, a display of other members in that member's network, and other useful tools.

With a robust network, many possibilities arise for real-world action. Groups organized in support of a particular cause may coordinate the efforts of many community members using wiki s, text chat, voice chat, video messaging, audio messaging, emailing, text messaging, and other tools. This energy may translate into petitions, protests, or boycotts. For example, a member may scan a barcode in a department store and automatically cross-reference it with a list of products boycotted by groups in his network prior to making a purchase.

“Global clout” is the aggregation of all of a community member's “local clout.” Icons next to a member's name may indicate global and/or local clout. Global clout above a certain threshold empowers a member to participate in certain activities such as serving as a moderator or as a judge on the Court of Appeals. When any user notices inappropriate content, he may flag it as such. A tool to aggregate flagged content enables moderators to investigate further. If several moderators determine that certain flagged content is indeed inappropriate, then the content becomes restricted, and its author is reprimanded. The author may appeal this outcome to a Court of Appeals comprised of members with even higher global clout than the moderators. The Court of Appeals may take punitive action against the author and/or the moderators as it sees fit.

The system can incorporate a search functionality enabling locating debates or argument modules by keyword, date, rating, views, or other identifying features. One such identifying feature is a taxonomy of user-generated tags.

### Additional Embodiments

The invention may take additional forms not overtly outlined within the detailed description yet still falling within the limits of the specified claims. Several such forms are outlined below.

The invention may exist on an internal, private electronic network for a business or government agency. Such entities may find the system useful in organizing diverse and conflicting viewpoints of their many employees, consumers, or stakeholders.

The invention may exist in read-only form on third-party websites with the permission of the patent holders.

The system's method for determining local clout may also take into account the ratings of users from the opposing side of an issue.

Debates may also take a less contentious, less restrictive form, where anyone may post to either side of the debate in order to allow collaborative consideration of the pros and cons of the proposition.

At the conclusion of a debate when both sides consolidate and summarize their positions, they may also be able to annotate which arguments on their side are most influential in making their case and they may also indicate which arguments from the opposing side they view as common ground. Statistics on the percentage of users who view certain arguments as common ground will also be available. Users may choose to make their voting and rating records public, and the system may have a method of comparing and contrasting these records to those of other users. All users may be able to help draft the conclusion for their side of the debate, and those users with a local clout above a certain threshold may have moderator privileges.

The core debate functionality may also take several forms. The creator of a debate may choose to not make the Response Phases distinct from the Rating Phases. The creator may also limit participation on the sides of a debate to a subset of named members, members with a global clout above a certain threshold, or by some other method. Both sides may rate each other's arguments or they may be limited to only rating their own side. In the case where a user may only rate his own side, the system provides a method such as a checkbox whereby the user may accept an opposing argument as common ground. In the case where the Response and Rating Phases are distinct, users may further be able to modify their previous ratings. If an author wishes to retract a point, he may flag it as such, but it will remain visible to all other participants in the debate.

The system may contain a method for proposing points prior to their final posting. Other users may comment and fine-tune proposed points before they become published and unable to be edited. This method may include communication tools such as text-, audio-, and video-chat.

The foregoing discussion focuses principally on conducting and facilitating debate. It is understood, however, that other applications of the system and method will also be useful in any arena of dialogue or information gathering. For example, the application could be used for suggestion boxes. In addition, the present invention could be advantageously applied in the areas of voting, education, training, aggregate product reviews, peer reviews, and as an alternative to traditional forum software.

As noted above, while the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for conducting a debate over an electronic network comprising:
creating a plurality of point modules in competition with each other for favorable positioning within said debate;
creating counterpoint modules whose value is independent of said plurality of point modules, wherein a plurality of said counterpoint modules are in competition with each other for favorable positioning within said debate; and
graphically depicting the relationship between said points and said counterpoints, whereby a plurality of users can assemble a singular collective knowledge through a plurality of diverse modular contributions.

2. The method of claim 1, wherein said point and counterpoint modules are standalone and non-revisable.

3. The method of claim 1, further comprising revising said point modules and said counterpoint modules.

4. The method of claim 1, wherein a plurality of said point modules are subcomponents of a separate point module and a plurality of said counterpoint modules are subcomponents of a separate counterpoint module.

5. The method of claim 1, whereby prior to submitting a counterpoint, a community member categorizes said counterpoint as one or more of the following:
a. challenging an explicit or implicit assumption;
b. challenging an explicit fact;
c. challenging the stated logic; or
d. making a new, related point.

6. The method of claim 1, further comprising rating said point and counterpoint modules based upon one or more of the following:
a. an internal logic associated with each of said modules;
b. a supporting evidence associated with one or more of said modules;
c. an applicability to one or more of said points or counterpoints; or
d. user preference; and
wherein the ranking of a module is independent of the ratings of all other modules;

7. The method of claim 6, further comprising categorizing at least one of said point or counterpoint modules as common ground.

8. The method of claim 7, further comprising indicating a local clout within a single side of a debate by weighting a rating for each of said community members, said rating derived from other members.

9. The method of claim 8, further comprising indicating a global clout by granting privileges and responsibilities to one or more members with a strong record of local clout.

10. The method of claim 1, further comprising setting a collective agenda by proposing or ranking a plurality of topics, resolutions, or plans of action for future consideration.

11. The method of claim 1, further comprising voting for, against, or neutral to a proposition or plans of action.

12. The method of claim 1, further comprising proposing a voting on the importance of particular values or interests related to the topic at hand.

13. The method of claim 1, further comprising collaborating in drafting a conclusion representing a particular side of a debate.

14. The method of claim 1, further comprising creating and maintaining profiles containing individual/group data and a platform of debate propositions they support and/or oppose.

15. The method of claim 1, further comprising providing a virtual toolbox of collaborative software such as wikis, chat rooms, instant messaging, and short message service (SMS).

16. The method of claim 1, further comprising graphically representing a plurality of tree structures comprising electronic folders and files or the hierarchical structure of websites and their URLs, and wherein the user is able to customize and save the graphical representation of their file pathways according to at least one of the following criteria:
a. most commonly visited;
b. most recently visited; and
c. user preference.
